(19) United States
(12) Patent Application Publication
(10) Pub. No.: US 2016/0086231 A1
(43) Pub. Date: Mar. 24, 2016

(54) Method and software for rapidly connecting consumers with repair services

(71) Applicant: Matan Darey, San Diego, CA (US)

(72) Inventor: Matan Darey, San Diego, CA (US)

(21) Appl. No.: 14/495,479

(22) Filed: Sep. 24, 2014

(51) Int. Cl. G06Q 30/02

(52) U.S. Cl. CPC G06Q 30/0269; G06Q 30/0267

(57) ABSTRACT

Internet website, communication means, databases, software matching engine, and business method that collectively allow a consumer to rapidly enlist the services of an appropriate repair resource, facilitated for fee by the Operator of the present invention.

### CROSS-REFERENCE TO RELATED APPLICATIONS

This application claims the benefit of priority of U.S. Provisional Application No. 61/737,721, filed 26 Sep. 2013 for Matan Darey, which is incorporated herein by reference in its entirety.

### FEDERALLY SPONSORED RESEARCH OR DEVELOPMENT

Not applicable

### BACKGROUND OF THE INVENTION

1. Field

The present invention is generally in the field of repair services and providers thereof.

2. Description of the Problem

There is a statistical incidence of urgent failures of certain common and relied-upon household and vehicle systems, tools, and facilities. Some such issues are emergent in nature. Plumbing problems can include flooding, electrical problems can cause loss of important medical and communication tools and defrosting of valuable stored food, roof leaks can damage the structure and cause internal damage to carpeting and furniture, vehicle failures can create transportation crises, loss of keys or failure of a lock can prevent access to property at a critical time, home or business structural issues can create danger to occupants and assets, pest control issues can deny access to a space or—in the case of dangerous pests such as wasps—cause injury.

When such a functional emergency occurs at a business or home, or with a vehicle, methods for locating and negotiating with repair resources have been accelerated in the recent past with the emergence of cellular telephony and internet communication. However, even with such relatively new technology supporting the dialog between consumer and repair service, arranging an appointment can take hours between the negative occurrence and the arrival of a selected repair resource on the scene. This is true whether the resource is located using the internet, telephone directory, print advertising and telephone, or referral by an associate or friend. Generally, urgent problems are addressed within a few hours, but that delay can increase damage or otherwise be costly. Some consumers maintain an accessible list of known and trusted tradespeople (plumbers, electricians, locksmiths, etc.) to expedite contact when an urgent situation arises, but too often the selected resource is committed to another problem and is simply unable to respond to the situation as rapidly as the consumer wishes. There are no reliable methods for instantly bringing competent repair resources to the site of urgent problems.

Discussions with trade union representatives suggest that such urgent requirements for skilled trade services occur at least 15 times 1,000 people per year. Excluding normal-priority reparis, a city of one million residents will experience at least 15,00 urgent repair situations annually. That number varies depending upon the definition of “urgent”, but even if the number varies by 50%, this situation creates an opportunity for a centralized business, software, and communication solution that can utilize the most applicable available technologies to accelerate the arrival of a qualified tradesman on the scene, support negotiation, and otherwise facilitate rapid remediation of the problem. Such a method should also permit consumer grading of perceived tradesman performance, thus assisting subsequent consumers in selecting providers. No method, with supporting software and communication tools, exists to meet that goal.

3. Technology

The internet is the largest and most complex communication, advertising, and matchmaking (between people, businesses, requirements and solutions, etc.) mechanism used by humankind. Usage of common telephones is diminishing rapidly with the proliferation of “smartphones”, able to communicate, access the internet, take high-quality photographs, maintain personal databases (phone, etc.), and otherwise facilitate information management and communication.

These resources emerged relatively recently and are evolving rapidly, so it is understandable that such technological capabilities are constantly creating new businesses and solutions to problems, permit identification and exploitation of opportunities, and otherwise change the business, social, and personal behavior of society.

4. Technology-Based Solutions to the Problem

Software evolution now permits an internet browser to display a form that enables a website visitor to provide information to the website Operator. The visitor will probably be a user of services provided by the website Operator. Such sites and the communication thus facilitated are often in the area of the trades, including automobile repairs, locksmithing, roofing, electrical and plumbing repairs, and similar services. The website's software often sends an alert to the website's owner's smartphone, advising of the problem, location, etc. The use of such online communication, and the speed of response by the website Operator, are both increasing. But the response by the tradesperson operating the website depend upon the current workload and schedule, and even with such excellent communication there can be a delay of hours or, conceivably, days before the service provider arrives at the scene of the emergency. Meanwhile, the plumbing, electrical, computer, or vehicle problem is potentially causing a steady increase in cost and inconvenience to the consumer.

Some consumers and business Operators will maintain a list of trade services on their cellphones, greatly facilitating the connection to a service provider when an urgent situation arises. But even though technology enables the initial call to be made rapidly, the provider can be otherwise committed and the delay between order of services and arrival of the service provider at the scene can be costly.

One of the most successful methods that rapidly match trade services with work opportunities is in the area of locksmithing. A consumer who is unable to get into a car or building can telephone a central phone number and describe the problem, providing location and other pertinent information. A dispatching company operates the phone number, and the advertising (including a website) that promotes it. That website provides portals via which locksmiths can register, agreeing that in return for referrals they will pay a fee to the website/dispatcher company. The dispatcher takes the call and then polls registered locksmiths to find one that is proximate to the problem and able to do the described task, and assigns the job. The dispatcher will then call the consumer, advising of the locksmith's arrival time and probable cost. From the consumer's viewpoint, this is a more efficient way to quickly get a locksmith on the scene. However, this method has deficiencies. The locksmiths that subscribe to the dispatching service can be of varying quality. There is no “competition” for rapid arrival time at the scene. Price can vary from one provider to another. The dispatch service is costly to the participating locksmiths. There is no apparent means by which the consumer can see reports and ratings by other consumers that used a given locksmith's services.

There are similar online dispatching services supporting other trades.

The internet has facilitated the development of rating services, by which users of service can rate providers in a manner that can be seen by consumers that visit the rating service website. This has been very successful, and increases the confidence by the user of such services in the providers so identified. Various means have been developed to ensure that provider ratings can be made only by consumers, and not by the providers.

Despite these relatively recent technology-based solutions, many consumers will not or cannot tolerate hours of delay if the problem is aggravated by time, and they recruit neighbors, family, and friends to support their own effort to get the job done-often at a less than professional level the quality of which ultimately raises expense of the best solution. Depending upon the emergency, delay can be costly, damaging, and frustrating.

5. Requirement

Modern society is impatient, particularly when a problem has arisen. People want fast service at a reasonable price, and seek confidence that the provider of the required service will be competent. The consumer looking at a flooding kitchen feels at the mercy of the plumber that arrives, knowing that declining a quotation could lead to additional hours of flooding.

The dispatcher concept is a good working solution for most trades seeking to handle urgent (and even emergency) issues, and this business mechanism is more efficient than a one-by-one search of service providers by the consumer searching for a rapid responder. That efficiency, and reduced response time, derives from the fact that the dispatcher may have many skilled trade providers available, awaiting a call to action. Despite the occasional use of dispatcher services to support some skilled trades, many independent tradespeople are less than 100% occupied with work. At any given moment, an electrician or mobile mechanic might be idle, and that means a loss of revenue opportunity. Discussions with tradespeople confirm that they would rather work at a discount than not work at all. That is partly because the charge made for work performed must also compensate for time when no work is available.

Many communication methods, businesses, dispatching services, task-scheduling, and work-assignment tools have evolved, but none found in patent filings or in the marketplace provides the combination of convenience, cost, speed, confidence, and efficiency created by the present invention.

6. Definition of a Potential Solution

Discussions with consumers and with tradespeople, and a review of dispatcher services, have confirmed the desirability of technology that exploits technology to:
Automate the consumer's report of a problem and search for services.
Reduce the time it takes between detection of a problem and arrival of the solution
Standardize payment, diminishing on-the-scene negotiation.
Provide a means by which consumers (and consumers only) can rate service providers.
Enable such ratings to be seen by other consumers seeking similar services.
Provide more revenue-generating working hours per unit time to service providers.
Give service providers confidence that they will be paid.
Reduce cost to the consumer and to the service provider, improving the economy of the emergency service.
Reduce the average delay between problem and correction, often reducing collateral damage and associated costs.

7. Prior Art

Existing and historical means to connect employers and providers of trade services include every form of communication, and every means by which communication data are stored (internet, telephone directory, household handbooks, etc.).

In reviewing prior art, the dispatcher mechanism, with online and telephone support, comes closest to solving the problem, but that means is deficient because of limitations described above.

Several services provide internet websites designed to connect customers with various skilled trade providers. “Angie's List” offers a means by which a requirement for a plumber, for example, can be met from a list of approved resources. The objective is to give the consumer confidence regarding the quality and trustworthiness of recommended providers, based upon recommendations by other customers. “Home Advisor” also operates a website connection service, wherein a consumer can list the characteristics of a project (carpentry, painting, etc.) and the service will connect that consumer to candidate providers who then compete for the work.

These online services fail to address immediate emergency or critical situations, and the service provided is ordinarily scheduled in hours or days, not minutes.

No smartphone-based resource was found to address urgent repair situations.

8. Objectives of the Present Invention

The primary objective of the present invention is to reduce the time between a consumer's need for repair services and the arrival on the scene of a competent skilled trade provider. Other objectives are to:

a. Give providers of trade services (such as electricians, locksmiths, roofers, plumbers, carpenters, mechanics) more revenue-generating opportunities, reducing “down time”.
b. Provide confidence to the consumer regarding the quality of work performed by service providers.
c. Provide a means by which the work can be done at a price that is profitable for the provider and acceptable to the consumer.
d. Enable the consumer to take one or more smartphone-based photo(s) of the problem and provide them to the service provider, thus facilitating an optimum fit between the task and the provider's skills, and also supporting a better fit between quotation and final price.
e. Provide a chat means via either or both computer and smartphone, by which the service provider and potential customer can exchange information such as a description and images (of the problem), and can negotiate.
f. Provide an overall efficiency and cost-effectiveness improvement in relationships between providers of trade services and the users thereof.
g. A business objective of the present invention is to create and facilitate the operation of a matching service between consumers with problems and tradespeople that can solve them, with the Operator of the present invention acting as a paid brokerage.
h. Another business objective is to partly reduce promotional expenses incurred by the providers of trade services, improving the relationship between cost and benefit when using the present invention as opposed to conventional advertising. The portion of the fee paid to the Operator of the present invention is designed to be less than the cost of advertising.

### BRIEF SUMMARY OF THE PRESENT INVENTION

The basic function of the present invention is to reduce the time required to get faults, leaks, outages, and breakages repaired, by accelerating the process by which a qualified repair technician is brought to the site of the problem.

The present invention is comprised of a personal communication means such as a consumer's smartphone or computer, with software that enables said consumer to report a present need for repair service, see available solution-providers that are found to be close in proximity based upon the service provider's smartphone's Global Positioning System (GPS) or cellular-based location-determination capabilities, select a service provider based upon ratings by past users of providers, and rapidly get an available and selected provider at the site of the problem.

It includes a website database on which tradespeople or service providers can list their capabilities, locations, and contact information, making them suitable for matches by the software of the present invention.

Other attributes of the present invention include payment methods enabling the Operator of the present invention to retain fees for services, and means by which consumers can rate providers, and providers can rate consumers, thus supporting improvement of future transactions.

### BRIEF DESCRIPTION OF THE SEVERAL DRAWINGS

FIG. 1 depicts the components of and participants in the present invention.

FIG. 2 depicts the Operator's databases for recording skilled trade resources.

FIG. 3 depicts screen displays provided to consumers and providers of services.

FIG. 4 depicts a form enabling a provider of services to subscribe to the present invention.

FIG. 5 depicts functions of the Operator and Software.

### DETAILED DESCRIPTION OF THE INVENTION

### 1. Assumptions

The present invention operates when the following technology resources are generally available: the internet as a communication and information display means, a browser (a software tool for accessing information resources via the internet), an operational local wireless telephone system, a smartphone typically able to display images, take photographs, access the internet, access the cellular communication service, and determine location through GPS or cellular site identification, all to connect to candidate service providers and via 3G, 4G, or other means pass information about the problem to the potential service provider via the telephone system or the internet.

### 2. Preferred Embodiment

Given the validity of those assumptions, the present invention operates as follows:
a. Tradespeople are invited to visit the website of the present invention to enter qualifications and certifications, areas of business operation, contact information, and limitations. Preferentially, labor sources will be provided by trade unions, so qualifications and certifications are validated.
b. The present invention operates a database containing such trade services information.
c. A smartphone application (“app”), which is a software product, can be downloaded by users of appropriate smartphones and installed in the phone's digital storage means.
d. When a problem is detected by the consumer, the app is loaded.
e. Within the app (or its equivalent on the website of the present invention) the consumer identifies the location and nature of the problem. If appropriate, said information can be supplemented by one or more image(s) taken by the smartphone.
f. A software matching engine that is part of the present invention then matches the problem with geographically convenient tradespeople.
g. Proximate tradespeople that are deemed by the Operator of the present invention to be capable of undertaking the task, and who have indicated that they are available to work immediately, will be notified by the software of the consumer's problem. The tradespeople will be given a limited time in which they must express their interest in providing the required repair service, at which point the software will advise the consumer of availability, ratings, and proximity of the service providers that responded.
h. The consumer makes a selection, of which all responding tradespeople are notified.
i. The selected tradesperson travels to the location of the problem.
j. The selected tradesperson and the consumer complete any negotiation on-site.
k. The selected tradesperson then provides the required service.
l. In accordance with the present invention, cost of arrival and/or of continuing services can be standardized.
m. The consumer pays for the service by paying the price of repair to the Operator of the present invention.
n. The Operator of the present invention retains an agreed-upon percentage of the payment and transfers the payment balance to the account designated by the tradesperson.
o. Upon completion of work, the consumer is invited to rate the provider.
p. Upon completion of work, the provider is invited to rate the consumer.
q. Thereafter, provider ratings are made visible to future provider and consumer ratings are made available to future consumers.
   3. Variations upon the Present Invention
a. Consumers can enter work and other data on the website, eliminating the need for a smartphone by capturing the service location and nature of the problem, and inviting uploading of descriptive imagery. This permits a computer-to-cellular connection, or a computer-to-computer connection that avoids the cellular network.
b. Tradespeople can register via a subset of the app used on smartphones.
c. The application can provide a built-in chat function enabling the service provider and consumer to communicate at any appropriate stage of the relationship, including that time after a service call has been made by the user and accepted by the provider. The chat function will enable the user and service provider to transmit text to one another completely within the application, thereby protecting the personal contact information of the user.
d. The purpose of the chat function is to permit the service provider to notify the user that he has arrived or that he cannot find the destination indicated by the user who made the call.
e. The built-in chat function will also maintain a log of all communications transmitted for quality assurance and to deter service providers and users from attempting to circumvent the service by canceling the work order through the application and working out a side deal.
f. Payment by the consumer can occur at any point in the process, including the payment of a deposit upon registration of the problem.
g. Payment can be via credit card, bank transfer, or an online payment medium such as PayPal.
h. Payment can be by the consumer to the tradesperson, with the Operator of the present invention achieving revenue by other means
i. A standardized hourly rate can be established for each trade, assisting both the provider and user of services in comfortably completing the transaction.
j. Hourly rate can be discounted when the tradesperson acknowledges the opportunistic nature of transactions based upon the present invention.
k. If tradespeople are provided a means by which they can “rate” consumers, then consumers with high ratings can be viewed as lower risk and therefore charged a lower rate for labor performed.
l. Additional revenue can be attained by the Operator of the present invention via advertising on the website and phone app.
m. The present invention can be used as a promotional tool by labor unions, seeking improvements in cash flow, services to their dues-paying constituencies, and public opinion.
n. The present invention can include non-urgent trade work, such as painting, landscaping, and general carpentry.
o. The present invention can improve the engagement by a consumer of professional services work from attorneys, accountants, financial advisors, and other non-trade providers at non-urgent levels.
p. These and many other variations and permutations of the present invention, obvious and less evident, are all inclusively within the scope of this document, and any automated computing and communication system designed to rapidly bring qualified and proximate tradespeople to the scene of an urgent repair problem is also within the scope of this document.

4. Glossary

In the following drawings and images, these terms will be used:
App (also Application)—a software program for Smartphones and/or Computers.
Computer—laptop or desktop computing and communication means by which the Consumer or the Provider can communicate with the Operator. A Computer can be used by either/both the Consumer and/or the Provider.
Consumer—the customer seeking trade services or repairs.
Consumer App—a software application developed by the Operator and installed on the computer or smartphone of the Consumer. For the purpose of the drawings that follow, the Consumer App may be used by the Consumer via either computing/communication device.
In the drawings that follow, it is assumed that Consumers have downloaded the Consumer App from the Operator's Website, and use it, whether by Computer or Smartphone.
Invention—the present invention.
Operator—the Operator of the present invention.
Problem—the urgent repair issue to be addressed by the Provider; can be plumbing, electrical, vehicle mechanical failure, roofing leaks, lockout, or similar urgent matters.
Provider—the provider of trade services or repairs.
Provider App—a software application developed by the Operator and installed on the Computer or Smartphone, or both, of participating Providers. In the drawings that follow, it is assumed that Providers have downloaded the Provider App from the Operator's Website, and use it, whether by Computer or Smartphone.
Smartphone—handheld computing and communication means by which the Consumer connects with the Operator to request assistance, and with the Provider after contact is facilitated by the Operator. A Smartphone can be used by either/both the Consumer and/or the Provider.
Software—the programming behind the Website that does selection, job assignment, communication, and other tasks required to complete the Service.
Website—the website of the Operator enabling Providers to enter data, capabilities, location, etc.

5. Drawings

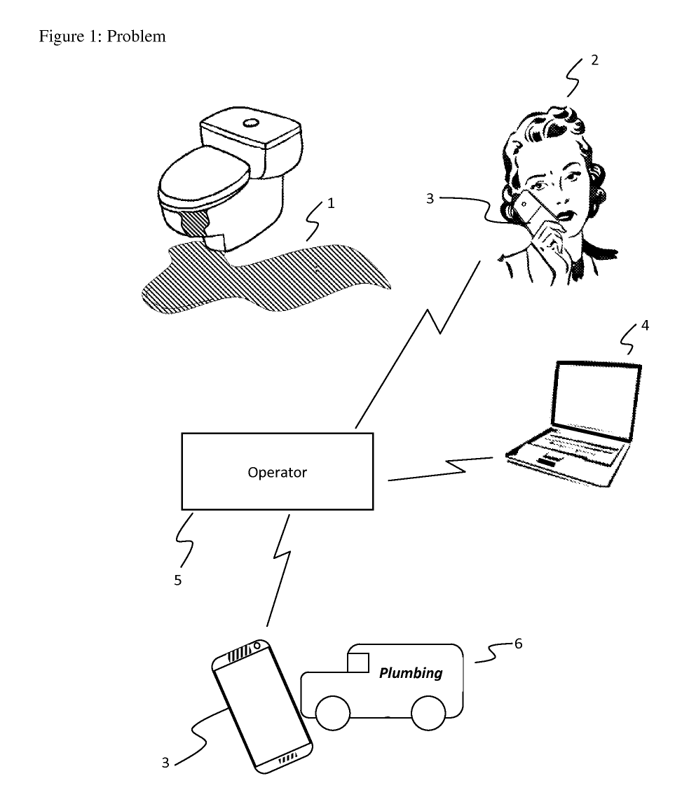

FIG. 1 depicts essential components of the Invention and their interconnection in dealing with the urgent repair Problem 1. The Consumer 2 uses the Consumer App on either a Smartphone 3 or Computer 4 to communicate with the Operator 5, which maintains a database of enrolled Providers 6 each of whom have a Smartphone 3 and/or other communication means enabling them to exchange information with the Consumer 2 or the Operator 6.

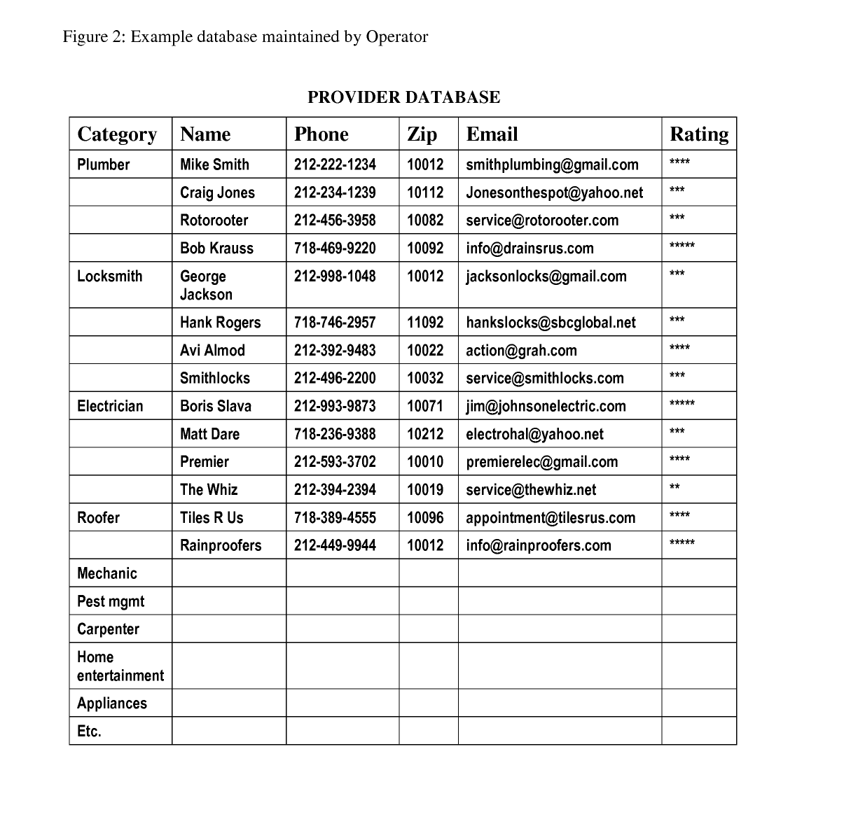

FIG. 2 depicts the Operator's databases for recording skilled trade providers that have subscribed to the Operator's program. Databases include plumbers, electricians, roofers, carpenters, vehicle mechanics, appliance repairmen, and other service Providers that enroll. Each category can include hundreds of Providers. The software of the Operator will select candidate Providers deemed to be proximate to the Problem, based on area code, exchange, or primary zip code.

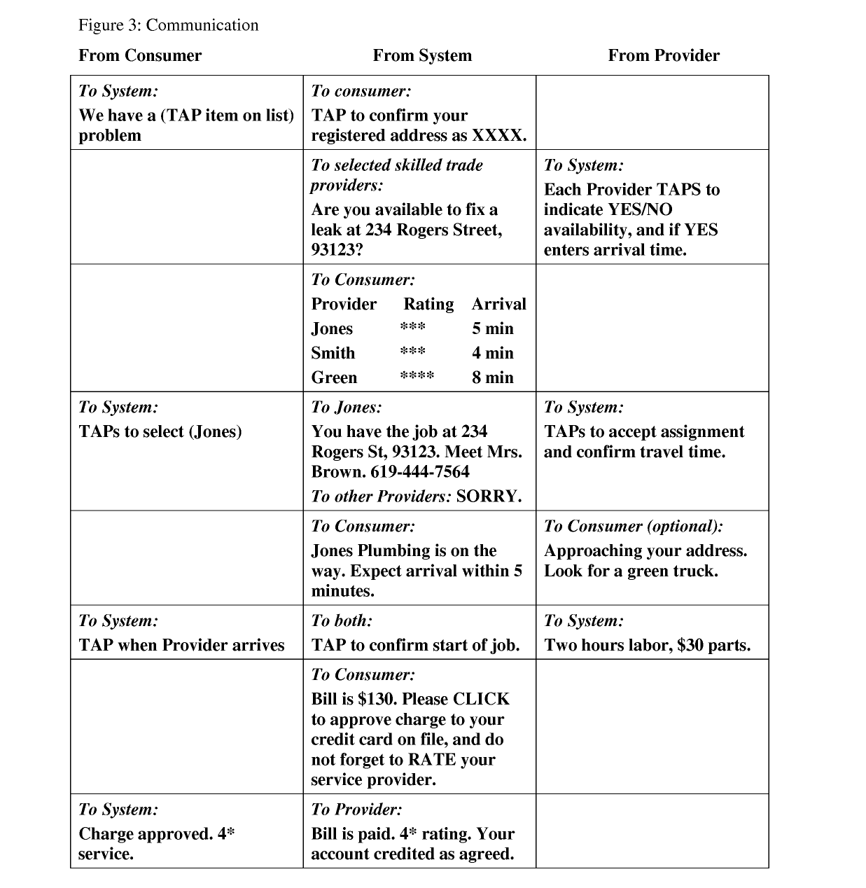

FIG. 3 depicts one example of possible screen displays produced by the Consumer and Provider cellphone applications (“apps”), which are similar to those generated when either or both Consumer and/or Provider use the Website rather than cellphone.

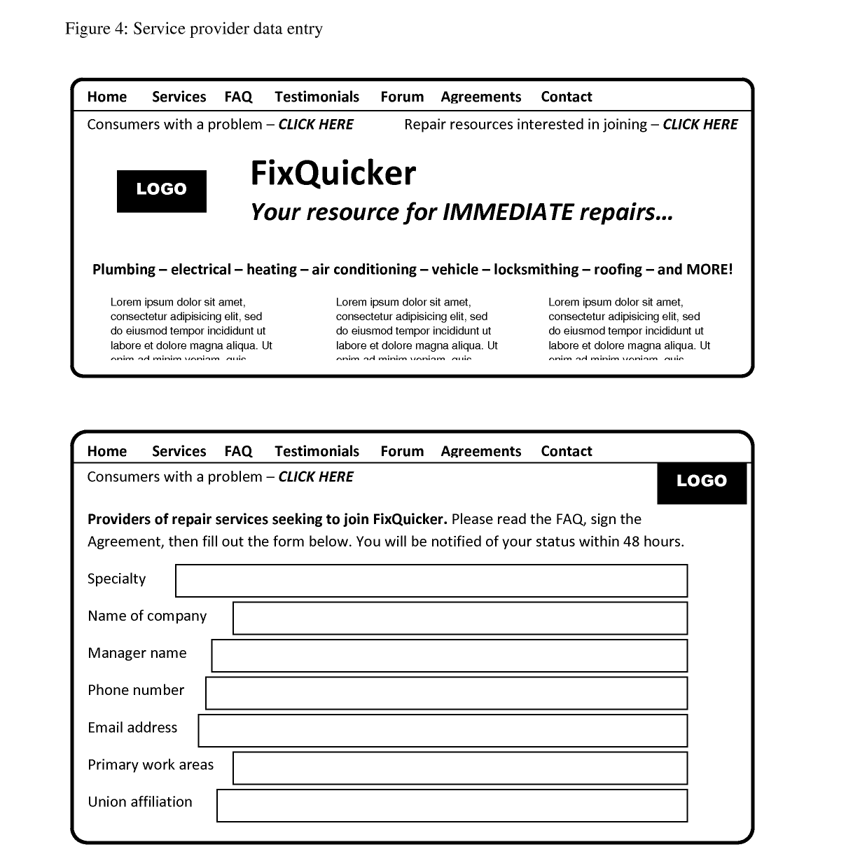

FIG. 4 shows an example of a form to be presented by the Website or Smartphone App to a potential repair services Provider seeking to participate in the Invention. Only a portion of the dialog between Provider and Operator is presented.

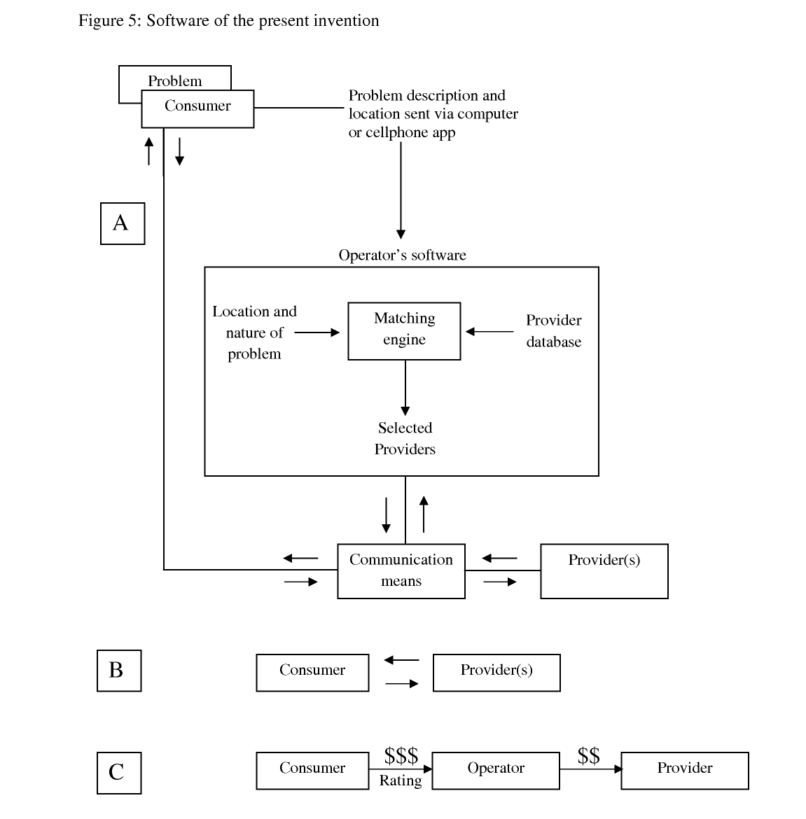

FIG. 5 depicts certain functions of the Operator and Software of the present invention. In process A, the Consumer recognizes the Problem and via Smartphone or Computer contacts the Operator for help. The matching engine of the Operator's software compares the nature of the problem and the location of the Consumer to the Provider database, and makes selections based upon ratings and proximity. The software communicates candidate Providers to the Consumer, and the Problem to candidate Providers, then turns over the conversation between Consumer and ready Providers who communicate directly as in process B. In process C, the Consumer makes payment to the Operator, who retains a fee and pays as appropriate to the Provider. In addition, the Consumer is given an opportunity to rate the Provider.

Other functions and components of the Invention, such as specific payment via the internet and communication via computer and cellular telephony, are known so are not shown.

I claim:

1. A business method and software tools that enable providers of skilled trade services to list their capabilities via a website data entry means, and that enable a consumer seeking a rapid solution to a repair problem to connect with providers of skilled trade services who have listed their capabilities on said website, with software that recognizes the consumer's requirement and polls appropriate service providers using cellular telephone means and then recognizes the service providers that report rapid availability, and provides to the consumer a list of available service providers and their estimated time to reach the site of the problem, thus enabling the consumer to quickly identify the best available service provider able to rapidly reach the scene, minimizing the delay between recognition of the problem by the consumer and arrival on the scene of a capable provider of required skilled trade services.
